(19) United States
(12) Patent Application Publication
(10) Pub. No.: US 2024/0120750 A1
(43) Pub. Date: Apr. 11, 2024

(54) METHODS AND APPARATUS FOR DYNAMIC BATTERY MANAGEMENT

(71) Applicant: Infinity X1 LLC, Carlsbad, CA (US)

(72) Inventor: Dennis K. Bertken, Carlsbad, CA (US)

(73) Assignee: Infinity X1 LLC, Carlsbad, CA (US)

(21) Appl. No.: 18/480,749

(22) Filed: Oct. 4, 2023

Related U.S. Application Data
(60) Provisional application No. 63/378,238, filed on Oct. 4, 2022.

(51) Int. Cl. H02J 7/00

(52) U.S. Cl. CPC H02J 7/0013; H02J 7/0048; H02J 7/007182

(57) ABSTRACT

Systems, apparatus, and methods for dynamic battery management. Historically, most portable devices were designed to work with dry cell and rechargeable batteries which provided a stable power level that slowly dropped over time. More recently, however, some products have implemented dynamic loading capabilities—dynamic loading potentially offers better performance, longer battery life, and/or improved functionality. Unfortunately, dynamic loads have highly variable voltage readings that present a challenge in estimating remaining battery capacity. Various embodiments of the present disclosure provide power from multiple different power sources with different characteristics and/or capabilities. The power sources are monitored and dynamically loaded according to their capability. Additionally, the estimated usage may be provided to the user to inform them of e.g., remaining capacity, ongoing current draw, etc.

### PRIORITY

This application claims the benefit of priority to U.S. Provisional Patent Application Serial No. 63/378,238 filed Oct. 4, 2022 and entitled “METHODS AND APPARATUS FOR DYNAMIC BATTERY MANAGEMENT”, the foregoing incorporated by reference in its entirety.

### Related Applications

This application is related to U.S. patent application Ser. No. 17/315,292 entitled “BROAD VIEW HEADLAMP” filed May 8, 2021, U.S. patent application Ser. No. 16/097,948 entitled “ADAPTIVE FLASHLIGHT CONTROL MODULE” filed Oct.31, 2018, and U.S. Provisional Patent Application No. 63/266,797 entitled “HYBRID BATTERY CARTRIDGE” filed Jan. 14, 2022, each of the foregoing being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of lighting and portable power devices. More particularly, the present disclosure relates to a smart lantern that dynamically manages hybrid power sources (e.g., single-use and rechargeable batteries, solar, external USB, and/or mains power).

### DESCRIPTION OF RELATED TECHNOLOGY

Batteries provide power for many portable devices. Most batteries include one or more electrochemical cells. When a battery is supplying electric power, its positive terminal is the cathode and its negative terminal is the anode. The negative terminal is the source of electrons that will flow through an external electric circuit to the positive terminal. When a battery is connected to an external electric load, a redox reaction converts high-energy reactants to lower-energy products, and the free-energy difference is delivered to the external circuit as electrical energy.

Single-use (also known as “disposable”, “primary”, and/or “dry” cell) batteries are used once and discarded because the electrode materials are irreversibly changed during discharge; one common example is the alkaline battery used for a multitude of portable electronic devices. A “dry” cell uses a paste electrolyte, with only enough moisture to allow current to flow. Unlike a wet cell, a dry cell can operate in any orientation without spilling, as it contains no free liquid, making it suitable for portable equipment. Other battery chemistries that may be found in single-use batteries include zinc-carbon cells, lithium cells, mercury cells, and silver-oxide cells.

Rechargeable (also known as “secondary” cell) batteries may be recharged and discharged multiple times. To recharge the cell, an electric current is applied to the cell to restore the original composition of the electrodes. Rechargeable batteries include lithium-ion batteries used for portable electronics such as laptops and mobile phones, and lead-acid batteries used in vehicles. Other battery chemistries that may be found in rechargeable batteries include nickel-cadmium cells and nickel-metal hydride cells.

Batteries come in many shapes and sizes; miniature cells may be used to power hearing aids and wristwatches—at the other extreme, huge battery banks the size of rooms may provide standby or emergency power for telephone exchanges and computer data centers. Flashlights and handheld devices often use “cylindrical cells”; cylindrical cells may be either single-use or rechargeable. Historically, cylindrical cells were commonly referred to by a generalized size nomenclature “AA”, “AAA”, “C”, “D”, etc. More recently rechargeable battery manufacturers have adopted more physical form factor nomenclatures (e.g., 18650 refers to a lithium-ion battery of 18 mm×65 mm; 14000 refers to a lithium-ion battery of 14 mm×50 mm, etc.) Cylindrical cells may be used “loose” or in-battery cartridges/racks.

Solar panels are another common power source for portable devices. Photovoltaic devices (“solar cells”) can convert light into electricity. Typically, a single solar cell can produce ˜0.5 volts (V) at a few milliamps (mA); multiple solar cells may be chained together into solar panels to provide any arbitrary voltage and/or current. While solar power is free and emission-less (“clean”), solar panel efficiency quickly drops off under inclement weather/darkness. Other less common power supplies may also be used for portable power generation; these may convert e.g., chemical, mechanical, acoustic, and/or thermal energy into electricity. Examples include fuel-based generators, fuel cells, piezo-electric cells, etc.

Some portable devices can be powered and/or charged via an external power supply. So-called “mains” or “wall” power devices can use the alternating current (AC) electricity provided by the electrical power grid. While mains power may offer practically unlimited power, the transformer components and reliance on access to an electrical grid presents significant problems for most portable applications (e.g., camping and/or new construction use). Other external power interfaces within the consumer electronics arts include the Universal Serial Bus (USB) and its variants, as well Power over Ethernet (PoE); these technologies have similar limitations.

Historically, power has been a collateral, yet unavoidable, factor in product design. Each of the technologies has its own unique considerations; consequently, most portable devices are designed with only one or two power sources to simplify product operation.

### BRIEF DESCRIPTION OF THE DRAWINGS

FIG. 1 is a graph illustrating exemplary discharge curves for single-use and rechargeable batteries.

FIG. 2 illustrates voltage measurements for a Pulse Width Modulated (PWM) Light Emitting Diode (LED), useful to illustrate battery capacity measurements under dynamic loading conditions.

FIG. 3 is a logical block diagram of one exemplary lantern, useful in accordance with the various techniques described herein.

FIG. 4 is a graphical representation of one physical form factor corresponding to one exemplary lantern (such as described in FIG. 3).

FIG. 5 illustrates a logical block diagram of one generalized system, useful in conjunction with the various techniques described herein.

FIG. 6 illustrates logical flow diagrams of methods for power management and monitoring in accordance with the various techniques described herein.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### 1 Single-Use and Rechargeable Batteries

Battery powered products today provide the singular option of single-use battery power or rechargeable battery power. This “either or” scenario dramatically limits the ability to use the battery power products in many cases. Compared to rechargeable batteries, single-use batteries store charge longer in extreme temperatures and when not in use (the so-called “self-discharge rate” is the rate at which the stored charge in a battery is reduced due to internal chemical reactions of the battery). Certain types of alkaline batteries, for example, have a shelf life of ten years. Single-use batteries are therefore well suited for emergency-use applications.

Single-use batteries must be replaced after use, thus a cost comparison of single-use batteries and their rechargeable counterparts should consider replacement cost and access to recharging power. Many high-power output products today consume single-use batteries in just a few hours, and performance is frequently inferior to rechargeable batteries at low battery life. Replacement costs can quickly eclipse the low per unit cost of single-use batteries. Further, rechargeable batteries, while having a larger up-front cost than single-use batteries, can be recharged with relatively inexpensive power from, e.g., an outlet. As a result, rechargeable batteries allow for more cost-effective use over their lifetime. Unfortunately, rechargeable batteries require access to external power DC power to recharge the batteries. If the power is out or a person is away from the DC power source, then they can find themselves without the ability to power their devices.

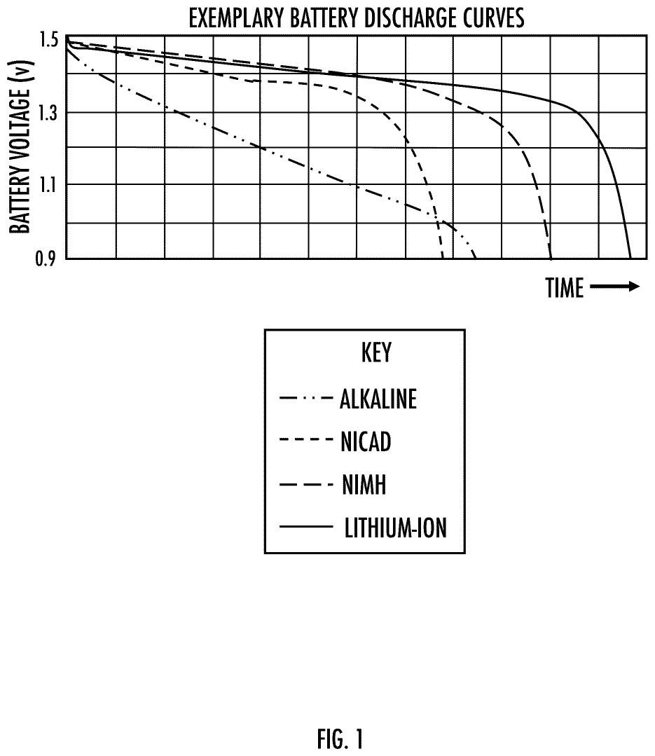

FIG. 1 is a graph illustrating exemplary discharge curves for single-use and rechargeable batteries. The graph illustrates the discharge curves (voltage) of four types of battery chemistries over time of use. Alkaline manganese dioxide (alkaline) batteries are single-use batteries. Nickel-cadmium (NiCAD) batteries, nickel-metal hydride (NiMH) batteries and lithium-ion batteries are rechargeable batteries. Even though all battery chemistries lose voltage over time, alkaline batteries (which are the most popular type of single-use battery) lose voltage at an almost constant rate over the span of discharge. Rechargeable battery chemistries lose voltage at a far slower rate, and drop-off before the battery is depleted. Conventional wisdom suggests that the differences in discharge rates means that single-use and rechargeable cells should not be directly electrically coupled together, since this may cause the cells to load one another unevenly and/or may reduce output, damage the cells, and in extreme cases, cause rupture and cell leakage.

The relatively constant rate of discharge for alkaline batteries simplifies battery-life determination compared to other battery chemistries; the remaining alkaline battery life can be directly estimated based on the output voltage (when not under load). Unfortunately, the lack of a consistent voltage level also makes the use of alkaline batteries less effective in certain types of applications, e.g., for use in electronics. In contrast, rechargeable battery chemistries can provide a relatively more consistent voltage level but may require more complex battery life determination (e.g., based on draw, temperature, usage, etc.)

### 2 Pulse Width Modulated (PWM) Loads

Most portable devices are designed to work with dry cell and rechargeable batteries. For example, most flashlights, lanterns, and other lighting products directly run off the battery voltage (i.e., a static load). More recently, however, some products have implemented dynamic loading capabilities—dynamic loading potentially offers better performance, longer battery life, and/or improved functionality.

So-called Pulse Width Modulation (PWM) is one example of a dynamic loading strategy. Consider an exemplary PWM implementation that powers a Light Emitting Diode (LED) according to a selectable duty cycle. Specifically, the anode of the LED may be connected to the positive end of the battery source and the cathode of the LED may be connected to the drain of an N-Channel metal-oxide-semiconductor field-effect transistor (NMOSFET) switch. The source of the NMOSFET is connected to ground, and the gate is opened and closed by the PWM signal. The perceived brightness of the light is based on the duty cycle, e.g., 100% duty is the maximum brightness, 0% duty is off. Artisans of ordinary skill in the related arts will readily appreciate that other dynamic loading schemes provide similar behavior; these schemes may include e.g., Pulse Density Modulation (PDM), Pulse Amplitude Modulation (PAM), and other duty cycle-based modulation techniques.

Dynamic loading schemes provide substantial benefits over resistive dimming alternatives. NMOSFETs do not burn power during their off cycle which reduces power consumption and heating; this allows devices to stay cooler and last longer. Also, an NMOSFET is cheaper and smaller compared to power resistors. Unfortunately, these savings come at the cost of voltage stability, may also increase noise in the system.

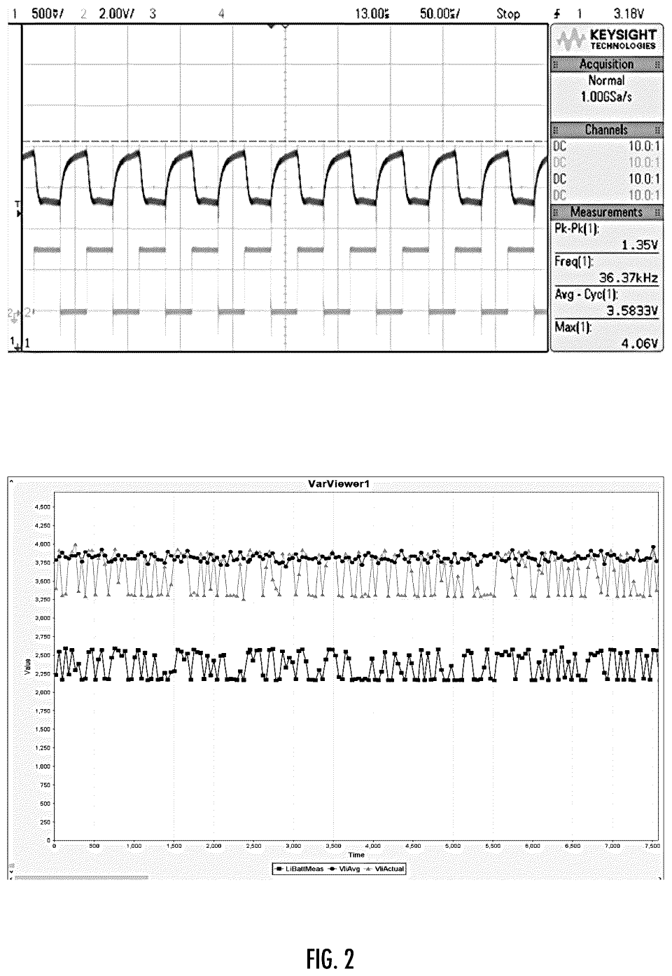

FIG. 2 shows a PWM LED implementation useful to illustrate battery capacity measurements under dynamic loading conditions. As shown, an NMOSFET gate is driven on/off at a 50% duty cycle. The battery and circuitry may also have internal resistances (R) and capacitances (C) which affect the rising and falling edges; for example, a square wave input will generate a rounded wave as the resistor—capacitor (RC) circuit charges and discharges (this effect may also be referred to as “1^{st} order decay”).

Battery capacity can be accurately measured based on Coulomb counting and battery voltage measurements. Unfortunately, these solutions are often cost prohibitive for low-cost applications. More cost-effective alternatives estimate the remaining charge based on the known discharge curve of the battery chemistry (such as was depicted in FIG. 1) and voltage measurements (using an analog digital converter (ADC)). Historically, most low-cost devices are designed for static loading, thus estimation has been an acceptable design choice. Notably, existing estimation techniques cannot be used under dynamic loading, since voltage is directly affected by the load (e.g., V=iR,

$$i = C \frac{d V}{dt} ,$$

and/or any impedance.) A PWM driven NMOSFET results in highly variable voltage readings that present a challenge in estimating remaining battery capacity. As shown in FIG. 2, directly sampling the 50% duty cycle may capture an off-phase or the RC decay. Typically, measurements at ˜50% duty cycle have the maximum amount of variation in the battery voltage; however, this may also vary based on current draw, sampling rate, etc. For example, large swings in current draw may cause erratic RC decay readings; similarly, irregular voltage sampling may coincidentally capture more off-phase measurements.

### 3 Exemplary Remaining Charge Estimation Under Dynamic Loads

One improved scheme for estimating remaining battery capacity compares a “rolling window” of voltage measurements against characteristic discharge cycles for different duty cycles. As a brief aside, the sampling rate of the battery measurement circuitry and the duty cycle are unlikely to exactly align. Different frequencies are orthogonal to one another within the frequency domain and will constructively and destructively interfere with one another according to a “beat frequency.” However, time averaging the varying voltage can be used to filter out the non-DC (direct current) frequencies, leaving only a non-zero DC voltage. Even though the non-zero voltage is not a direct measurement of voltage, it may be used to characterize the voltage discharge curve for that combination of duty cycle and sample rate. While the foregoing technique uses a rolling window calculation, artisans of ordinary skill in the related arts will readily appreciate that a variety of other calculations maybe substituted with equal success. Such other techniques may include time averaging, filtering, root-mean-square calculations, multiply-accumulate, and/or any other calculation that generates a characteristic non-zero value for a dynamic input.

More directly, battery voltage measurement data may be taken during a full discharge cycle at several different fixed PWM duty cycle values. Then, a “characteristic function” that describes the relationship between measured voltage and remaining battery capacity is determined based on one or more of: duty cycle, sample rate, battery chemistry, battery numerosity, battery configuration (parallel, series, etc.), or any other operational parameter. The characteristic functions can be stored within a device to enable subsequent determination of the specific battery capacity threshold based on the measured voltage.

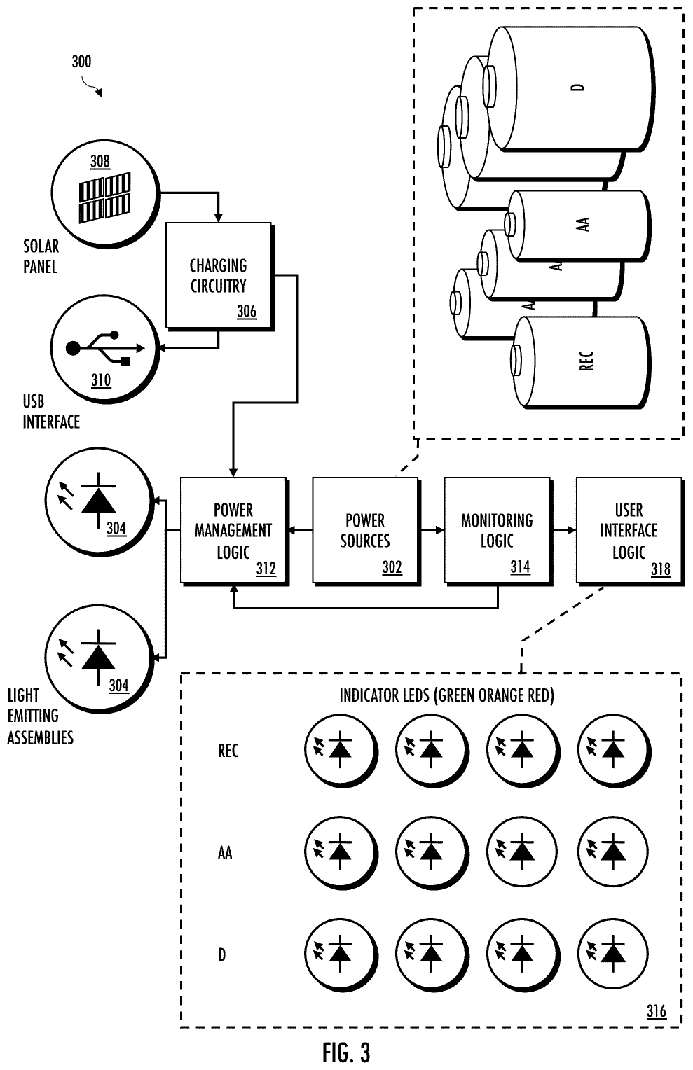

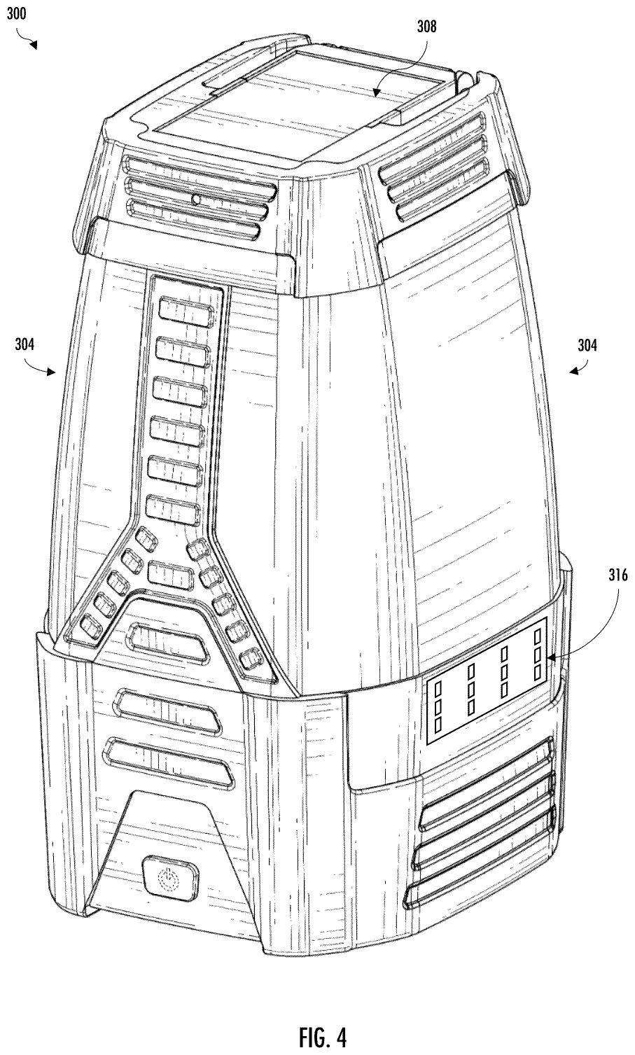

In one example, battery capacity estimation based on characteristic functions can be used with a device that supports multiple power configurations to support different operational modes. FIG. 3 is a logical block diagram of an exemplary lantern 300 useful to illustrate various aspects of the present disclosure. FIG. 4 is a graphical representation of the physical form factor corresponding to the lantern.

As shown in FIG. 3, the exemplary lantern 300 includes multiple available power sources 302. In the illustrated embodiment, the multiple power sources may include: a 3.7V lithium-ion battery (rechargeable), 3 AA batteries in series (4.5V low current draw), and 3 D batteries (4.5V high current draw). The lantern may also include light-emitting assemblies 304 (e.g., lenses, reflectors, and light emitting diodes (LED), etc.) The light emitting assemblies may be used together, or individually, in a variety of different modes (e.g., high intensity, moderate intensity, low intensity, night mode (red light), signaling (blinking) mode, etc.) While the following discussion is presented with reference to the exemplary lantern 300, artisans of ordinary skill in the related arts will readily appreciate that the following techniques may be broadly extended to e.g., flashlights, lanterns, work lights, battery packs, portable speakers, charging stations, and/or any other portable device having multiple power sources.

The exemplary lantern 300 may include charging circuitry 306 and associated interfaces to recharge its own rechargeable battery and/or other connected devices. For example, the illustrated solar panel 308 may be used to charge the 3.7V lithium-ion battery where there is sufficient ambient light. While, the lantern is described with relatively modest battery supplies, other charging interfaces (and associated power requirements) may be substituted with equal success. For example, heavy duty work site models may offer e.g., 12V and/or 18V battery pack charging (for power tools) while attached to a wall socket or mains power.

In some variants, the exemplary lantern 300 may include external charging and/or data transfer capability via an external interface. For example, some lanterns may include a USB port 310 to charge an attached smart phone or other peripheral device. Examples of such external charging interfaces may include e.g., mini-USB, micro-USB, USB-C, Lightning®, Power over Ethernet (PoE) and/or other power delivery interfaces. In some such variants, the lantern may also allow data/media transfer to or from an attached device. As but one such example, the lantern may serve as a speaker for playing music, a speaker and microphone “intercom” for hands-free cellphone operation, a device hub, an external hard drive for storing/transferring media, etc. Media playback assemblies may include associated components: e.g., a wired/wireless interface (e.g., USB™, Bluetooth®, Wi-Fi™, etc.), codecs, user interfaces, screens, speakers, and/or microphones.

Each of the operational modes (e.g., lighting modes, charging modes, data transfer/playback modes, etc.) may have different power requirements. The power management logic 312 (hardware, firmware, or software) selects one or more power sources from the multiple available power sources 302 that is suitable for the operational mode. In some cases, the power management logic 312 may select the power source based on the operational mode. For example, the lantern's high/moderate intensity lighting modes may draw large amounts of power and use the 3 D cell batteries; conversely, the low/night/signaling mode (or just one of the light-emitting assemblies 304) may draw smaller amounts of power and use the 3 AA cell batteries or the 3.7V lithium-ion battery. In some cases, the power management logic 312 may additionally consider the type of load and/or a reserve power threshold. Still other variants may allow the user to select the appropriate power source; for example, a user may want to manually switch between the rechargeable 3.7V lithium-ion battery and the 3 AA cells.

In one exemplary embodiment, characteristic functions may be stored into the monitoring logic 314 for battery capacity estimation. Specifically, the characteristic functions are measured and calculated for the exemplary lantern 300, at 100%, 75%, 50% and 25% duty cycles using a specified sample rate (e.g., ˜40 Hz). The characteristic functions correspond to each of the different battery configurations used by the lantern—for example, each of the 3.7V lithium-ion batteries (rechargeable), 3 AA batteries (dry cell), and 3 D batteries (dry cell) would have different characteristic functions. During operation, the monitoring logic 314 determines its battery configuration and collects time averaged battery voltage measurements. The monitoring logic 314 may use the measured voltage to look-up the estimated remaining battery capacity based on the specific characteristic function for the duty cycle, sample rate, battery configuration, operational mode, and/or any other relevant parameter. The estimated remaining battery capacity may also be used to calculate a rate of change in the remaining battery capacity—this rate of change corresponds to the estimated current draw. The estimated remaining battery capacity and rate of change are collectively referred to throughout as the “usage estimates.” The usage estimates can be provided to the user via the user interface logic 318. In some variants, the monitoring logic 314 may also inform the power management logic 312; for example, the remaining capacity and/or current draw may be used by the power management logic 312 to select an appropriate power source.

In one specific implementation, the user interface logic 318 controls a usage gauge 316 that visually represents usage estimates with a numerosity and color code; in this example, the first row of 4 light emitting diodes (LEDs) correspond to the 3.7V lithium-ion battery, the second row corresponds to the 3 AA batteries, and the third row corresponds to the 3 D batteries. The LEDs are enabled according to the estimated remaining battery capacity at the current duty cycle. For instance, 2 LEDs in the first row indicates that the 3.7V lithium-ion battery has about 50% of its capacity, 3 LEDs in the second row indicates that the 3 AA batteries have about 75% of their capacity, etc. Additionally, each LED emits light in one of three colors that dynamically correspond to the current draw: red (high current draw), orange (moderate current draw), and green (low/no current draw). So, as an example, if the first row is lit red, then the 3.7V lithium-ion battery has high current draw (and is rapidly depleting). If the second row is lit orange, then the 3 AA batteries are under moderate use, etc.

In one specific variant, the time averaged battery voltage measurements are calculated over a rolling window of values (e.g., 4, 8, 16, 32-value average, etc.) Notably, the battery voltage measurements are positive values so computationally simple addition and/or accumulation logic may be used. Applications that may have negative values may need more complex multiplication and/or polarity correction (e.g., RMS and/or energy estimation type logic). Typically, the instantaneous measured voltage may drop below the threshold for several readings in a row before the average voltage falls below the threshold. As a result, very large rolling windows may result in a “lag” or measurement hysteresis; conversely, very small rolling windows may be more strongly influenced by only a few sample points (noisy). Empirically, a 16-value average provides a good balance of stability and responsiveness for many lantern applications.

Some battery chemistries exhibit misleading behavior based on load and/or environmental factors. For example, certain types of batteries may have a “false” recovery that results in a higher resting voltage; however, the voltage rapidly drops to a more representative voltage under load. In other cases, batteries may have a different characteristic voltage based on ambient temperature, humidity, atmospheric pressure, etc. In some variants, the device logic (hardware, firmware, or software) may use a “ratcheting” level that prevents misleading behavior. In other words, the display cannot rise above a breached lower threshold until e.g., a battery has been changed/recharged or otherwise reset. For example, once the remaining capacity has fallen from 75% to 50%, the device logic will cap the subsequent readings to 50%. The device logic will only re-enable the 100% and 75% levels after a power cycle, batteries change (or charged), etc.

In some embodiments, the user interface logic 318 provides a continuous read-out. Other embodiments may allow the user to selectively check the battery usage estimates only “as-needed.” For example, all LED rows may be only momentarily lit when the user presses the ON switch, or a user may be able to individually check the power for only one of the power sources (e.g., a small push button may allow a user to check the status of just one of the 3.7V lithium-ion battery, 3 AA batteries, or 3 D batteries). Still other implementations may allow display status briefly at the start of and/or periodically during, a specific operating mode. For example, plugging a USB charging device may draw current from the 3.7V lithium-ion battery to start, and flash status every minute (via the first row of LEDs). Once the rechargeable battery is depleted, the external device may be switched to the 3 AA batteries—status may flash every minute via the second row of LEDs, etc.

More generally, the user interface logic 318 allows a user to determine the ongoing usage and remaining capacity for any one of the battery sources. In some cases, the user may be alerted as to when to change batteries, switch power sources, and/or reduce usage. As but one example, a user that is on a camping trip or a remote work site may not have ready access to disposable batteries. They may stop charging their smart phone to ensure that the lantern has enough power to continue lighting operation. Conversely, they may switch off the light and fully charge their cell phone to ensure they can call out for assistance. In other words, users can use their power usage information to budget their usage according to their needs.

While the foregoing discussion is presented in the context of a specific arrangement and/or color code of LEDs, other arrangements/color codes may be substituted with equal success. Notably, any number of LEDs may be used to signify capacity according to any specific granularity. As one example, 10 LEDs may be used to provide 10% increments (a linear scale). In another example, 4 LEDs may be used to provide logarithmic scale increments (e.g., 10%, 25%, 50%, 100%). Different colors may also be used e.g., red, orange, yellow, green, blue, indigo, violet, etc. to represent different current draws. Still other variants may switch the representation e.g., the color may indicate the percentage left, the number of lit LEDs may represent the current draw.

While the foregoing is described in the context of an on-lantern visual display, other user interface schemes may be substituted with equal success. In some cases, the notifications maybe audible and/or haptic. For example, beeps at different note pitches may be used to convey usage estimates. As but one such example, the number of beeps may indicate remaining capacity e.g., four beeps may indicate 100%, three beeps may indicate 75%, etc. The pitch of the beeps may indicate current draw e.g., 440 Hz (A₄ note) may indicate low/no draw, 523.25 Hz (C₅ note) may indicate moderate draw, etc. As another example, a “rumble box” may use similar numerosity/frequency schemes to convey information in a tactile modality. In yet other schemes, usage estimates may be wirelessly transmitted to a remote device (smart phone or laptop) that can remotely notify the user according to an application user interface. A wide variety of other user experience (UX) may be substituted with equal success.

### 4 System Architecture

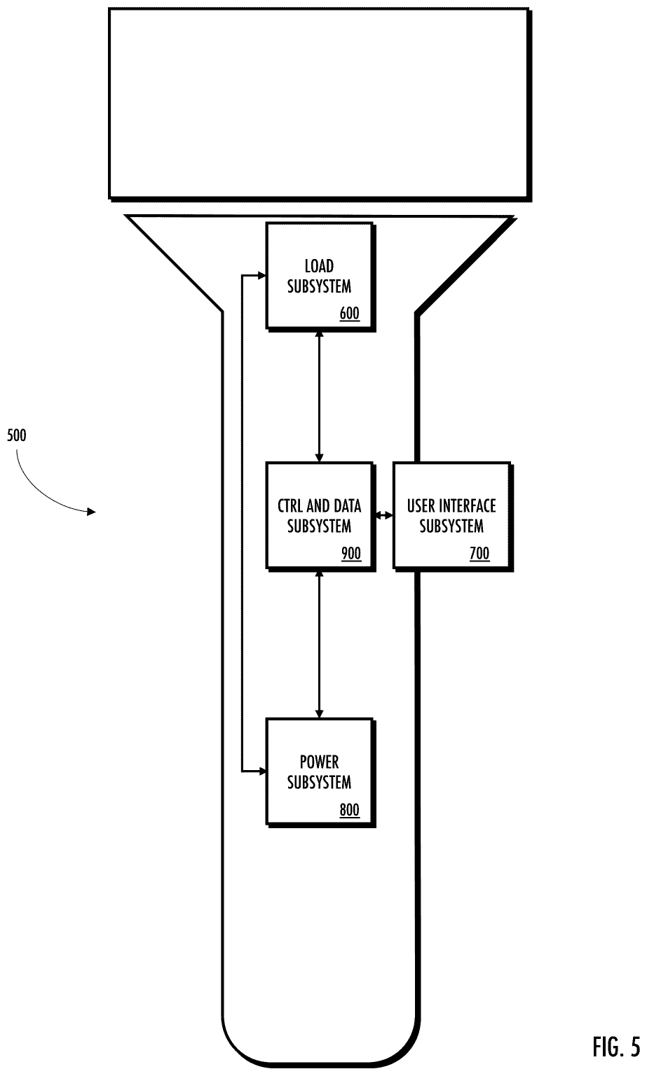

FIG. 5 is a logical block diagram of the exemplary system 500. The exemplary system 500 includes: a load subsystem 600, a user interface subsystem 700, a power subsystem 500, a control and data subsystem 900, within a housing. During system operation, the power subsystem 800 provides power from multiple different power sources with different characteristics and/or capabilities. The control and data subsystem 900 monitors the power subsystem 800 and/or the load subsystem 600 and adjusts power provisioning according to the dynamic loading activity of the load subsystem 600. Additionally, system status and user feedback may be provided to/from the user via the user interface subsystem 700.

While the illustrated housing is presented in the context of a lighting devices (e.g., flashlights, headlamps, lanterns, work lights, etc.), the system may have broad applicability to any system with multiple power sources would benefit from dynamic power management. Such applications may include personal, industrial, financial, medical, and/or scientific devices including e.g. radiant apparatus (e.g., visible light, infrared, ultraviolet, etc.), acoustic systems, sensor systems (photoelectric, thermoelectric, electrochemical, electromagnetic, electromotive, etc.), electromotive systems (motors, actuators, etc.), power systems (power banks, battery chargers, etc.), and/or any other portable powered apparatus.

The following discussion provides functional descriptions for each of the logical entities of the exemplary system 500. Artisans of ordinary skill in the related arts will readily appreciate that other logical entities that do the same work in substantially the same way to accomplish the same result are equivalent and may be freely interchanged. A specific discussion of the structural implementations, internal operations, design considerations, and/or alternatives, for each of the logical entities of the exemplary system 500 is separately provided below.

### 5 Load Subsystem

Within the context of the present disclosure, the load subsystem 600 consumes power that is provided from the power subsystem 800. In one aspect of the present disclosure, the load subsystem 600 dynamically varies its load; the dynamic characteristics of the load may be monitored to select, prioritize, or otherwise inform power provisioning (controlled by the control and data subsystem 900).

As used herein, the term “load” refers to any device or component that consumes electrical energy to perform a specific function. A dynamic load refers to an electrical load that varies its power consumption due to its operating conditions and/or the specific function it performs. A static load refers to an electrical load that has a constant power consumption.

An electrical load may be characterized according to the voltage (measured in “volts” (Joules/Coulomb)) and current (measured in “amps”, (Coulombs/second)) the load uses. Power consumption is typically measured in “watts” (volts×amps=watts (Joules/second)). Notably, power consumption is a function of impedance which has two components: resistance and reactance. Resistance measures opposition to the flow of electrical current, whereas reactance measures opposition to a change in electrical current. Reactance may be further sub-divided into inductive reactance and capacitive reactance. Inductive reactance stores energy in the form of magnetic field hysteresis; thus, the change in current “lags” the change in voltage. In contrast, capacitive reactance stores energy as differences in electrical fields thus, the change in current “leads” the change in voltage. The combination of resistance (real) and reactance (imaginary) describes a complex impedance having a magnitude and phase. Notably, reactance stores, but does not consume, power—thus, reactive components are not “dynamic loads” since they do not vary their power consumption.

Electrical systems that switch in/out portions of circuitry are one type of dynamic load behavior. For example, Pulse Width Modulation (PWM) and Pulse Density Modulation (PDM) circuits may switch on/off according to different widths or densities. Other examples include electrical subsystems that can be enabled/disabled either in whole or in part. For example, gate logic and other hardware may be enabled/disabled with clock gating and/or power gating. More generally, however, any time varying load may be substituted with equal success. For example, Pulse Amplitude Modulation (PAM) may increase/decrease impedance to affect the resulting amplitude. As another such example, variable resistances may be used to adjust current flow (e.g., potentiometers and/or rheostats) of analog circuits.

The permissible static and dynamic behavior of electrical signals may be parameterized for a load in a variety of ways. The following listing is illustrative, other load parameters may be used with equal success.

A “nominal” quantity is a specified or typical quantity (e.g., voltage, current, frequency, etc.) that an electrical or electronic component, circuit, or device is designed to operate under normal conditions. It serves as a reference value for the expected value. “Maximum” and “minimum” refer to the highest and lowest values, respectively, that a component, circuit, or device can withstand without suffering damage or exceeding its rated specifications. “Peak” and “trough” refer to the highest and lowest values, respectively, that a component, circuit, or device is designed for to maintain proper operation.

An “average” quantity characterizes a quantity over time. While “average” generally refers to an “arithmetic mean” average, other averages may be substituted with equal success. A non-limiting set of examples include: median, mode, geometric mean, harmonic mean, weighted mean, trimmed mean, etc.

An “average” quantity characterizes a quantity over time. While “average” generally refers to an “arithmetic mean” average, other averages may be substituted with equal success. A non-limiting set of examples include: median, mode, geometric mean, harmonic mean, weighted mean, trimmed mean, etc.

A “duty cycle” describes the fraction of time during which a periodic signal (such as a pulse or waveform) is in an active state compared to its total period. For example, an 80% duty cycle (sometimes also referred to as an 80/20 duty cycle) refers to a signal that is on for 80% of the cycle (and off for 20% of the duty cycle).

A “slew rate” refers to the rate at which a signal changes over time. For example, slew rates for voltages are often expressed as volts/microsecond.

A “spectral envelope” is a representation of the amplitude characteristics (magnitude) of the frequencies present in a signal or spectrum. It provides information about the dominant frequency components of a signal. A “roll-off frequency” is the point in a frequency response at which the amplitude or power of the signal begins to decrease rapidly. It is typically defined as the frequency at which the response is reduced by a certain amount, often measured in decibels.

The following discussions provide several illustrative embodiments of dynamic loads, however, artisans of ordinary skill in the related arts given the contents of the present disclosure will readily appreciate that the virtually any dynamic load may be substituted with equal success.

### 5.1 Transducer Components

As used herein, the term “transducer” and its linguistic derivatives refer to components that convert (transduce) energy from a first form to a second form. Forms of energy may include electrical, magnetic, chemical, mechanical, acoustic, optical, thermal, radio, etc. For example, an RF antenna is an example of an electromagnetic transducer (converting electromagnetic waves to/from electrical energy), a speaker is an example of an electroacoustic transducer (converting electrical energy to/from acoustic waves), an LED is an example of an electro-optical transducer (converting electrical energy to incoherent light), etc. Various embodiments of the load subsystem convert (transduce) electrical energy into another form to perform its task; dynamic transduction may entail dynamic loading.

In one embodiment, the load subsystem transduces electrical energy to electromagnetic radiation. EM radiation refers to oscillating electric and magnetic fields that propagate together in the same direction, perpendicular to one another. For example, the load subsystem may be a light module that generates visible light. The light module may include a bulb (incandescent, halogen), light emitting diode (LED), gas-discharge lamp (fluorescent tubes, neon, sodium vapor), lasers, or other light generating device. A bulb includes a wire filament enclosed in a vacuum or inert gas; the resistance of the filament is used to convert electrical energy to heat and light. An LED is composed of a diode junction manufactured from semiconductors with specific electroluminescent properties (e.g., gallium arsenide (GaAs), gallium phosphide (GaP), etc. When electrical energy is applied to the diode junction, electrons are forced to combine with electron holes; this process converts some electrons to photons (light). Gas-discharge lights pass electrical energy through ionized gasses; the ionized gases have quantum energy states so excess energy is released as EM radiation. The EM radiation is absorbed by a phosphor coating, which re-emits it as visible light. Lasers (light amplification by stimulated emission of radiation) use electrical energy to stimulate a gain medium (e.g., gas, liquid, solid); once energized, some atoms of the gain medium emit radiation. The emitted radiation triggers other atoms of the gain medium to emit more radiation; resulting in a rapid amplification of coherent light. The gain medium lies in a resonant cavity of the laser which allows continued amplification even as some portion of the light are output.

In addition to the light generating element, the light module may incorporate passive lenses, diffusers, reflectors, waveguides, and/or any other components or combinations of components configured to direct or disperse the light. For example, lenses are typically manufactured from a transmission medium (e.g., glass, acrylic, polycarbonate, etc.) which has been physically formed to bend (refract) light as it passes through. The lens physical shape may be convex (that causes light to converge), concave (that causes light to diverge), or a piecewise combination. In some applications, multiple lenses may be used in combination to provide refraction characteristics that are not possible (or practical) to implement with a single lens. Diffusers scatter, spread, and/or soften light as it passes through. Examples of diffusers include e.g. diffuser films, prisms, or translucent materials (e.g., frosted glass/acrylic, etc.). Reflectors reflect some (or all) of the light; reflectors are often used to direct light in a particular direction. Reflectors can be made from a wide range of materials, including metals, glass, plastics, and specialized coatings designed for specific wavelengths or applications. The design and geometry of a reflector determine its reflective properties and how it redirects or concentrates light. Waveguides use internal reflection to guide and confine light from one point to another; typical examples of waveguides include e.g. fiber optics for light as well as microwave waveguides and radio waveguides.

More generally, while the foregoing discussion is presented in the context of visible light applications (e.g., lanterns, flashlights, head lamps, work lights, etc.), any EM radiator (and associated peripherals) may be substituted with equal success. EM radiation spans a very wide spectrum from e.g., radio waves, microwaves, infrared (IR) or heat, visible light, ultraviolet (UV), x-rays, gamma rays, etc. Such devices may include e.g., telecommunications radios, microwave transmitters/ovens, IR transmitters/elements, UV lamps, X-ray lamps, etc.

In one embodiment, the load subsystem transduces electrical energy to acoustic waves. An acoustic wave is a mechanical wave that propagates through a physical medium (air, water, solids, etc.) by causing particles in the medium to oscillate or vibrate. In one exemplary embodiment, the load subsystem is a moving-coil speaker module that generates audible sound. Such speakers include a diaphragm (cone) that is attached to a coil, and magnet. When an electrical current passes through the coil, the coil generates a magnetic field that interacts with the magnet, causing the coil (and diaphragm) to move. Oscillating the diaphragm within certain frequency ranges and at sufficient magnitudes results in audible sound. Other examples of speakers include electrostatic speakers and planar magnetic speakers. Electrostatic speakers move an electrically charged diaphragm between perforated metal plates by changing the electrical charge of the plates. Planar magnetic speakers move a magnetic diaphragm using an electrically induced magnetic field. Each of these speaker technologies transduces electrical energy into acoustic waves.

Audio devices may include without limitation: audio/visual (AV) players (e.g., laptops, portable stereos, etc.), personal communication devices (e.g., walkie-talkies, smartphones, etc.), home/professional entertainment systems, public address systems, voice assistants, and/or any other personal, industrial, financial, medical, and/or scientific devices that employ audible sound.

Furthermore, much like light, acoustic waves exist on a spectrum that includes infrasound, audible sound, and ultrasound. While the foregoing selection describes audible acoustic applications, non-audible acoustic applications may use other forms of transduction. For example, ultrasonic transducers apply electrical current to piezo-electric elements to vibrate and generate ultrasonic acoustic waves. Ultrasonic waves are used for a variety of medical and industrial applications. Similarly, infrasonic waves may be generated by motors/vibrators; infrasound travels well in liquid/solid mediums and has applications in seismology and/or petroleum exploration, etc.

In one embodiment, the load subsystem converts electrical energy to mechanical movement. Typically, electro-mechanical movement uses electrical current in combination with permanent magnets to create attraction/repulsion forces. These techniques are commonly used in relays, solenoids, electric motors, stepper motors, linear actuators, servo motors, etc. Mechanical movement may include regular movements such as linear motion, reciprocating motion, rotary motion, oscillatory motion, as well as irregular movements such as cam-based motion, linkages, and eccentric motion.

Electro-mechanical devices may include without limitation: consumer electronics, hand tools and power tools (e.g., drills, screwdrivers, saws, sanders, routers, impact drivers, sprayers, heat guns, nail guns, rotary tools, random orbital sanders, and/or any other similar tools), and/or any other personal, industrial, financial, medical, and/or scientific devices that employ mechanical motion. While the foregoing selection describes electro-mechanical applications for hand-operated applications, artisans of ordinary skill in the related arts will readily appreciate that electro-mechanical motion may also be used in robotics, transportation, industrial automation, and/or drone-based applications. Such applications may also incorporate electro-mechanical transducers of extraordinarily small (or large) scale, such as piezo-electricity, nanotechnologies, etc.

While the foregoing discussion provides several illustrative transduction technologies, virtually any transduction technology with dynamic loading may be substituted with equal success, given the contents of the present disclosure.

### 5.2 Signal Processing Components

Aspects of the present disclosure may be used in conjunction with dynamic loads of signal processing. Signal processing refers to techniques that manipulate, analyze, and interpret electrical signals, which are representations of data in either analog or digital form. Functionally, semiconductors consume power during operation due to internal resistances. As a result, the dynamic loads associated with signal processing are a function of e.g., processing complexity (e.g., data size, compute cycles, memory accesses, etc.), dynamic behavior (e.g., enable/disable, load balancing, etc.), and/or application considerations (e.g., real-time budgets, best-effort processing, etc.).

As used herein, the term “real-time” refers to tasks that must be performed within definitive time constraints; for example, a video camera must capture each frame of video at a specific rate of capture. As used herein, the term “near real-time” refers to tasks that must be performed within definitive time constraints once started; for example, a smart phone must render each frame of video at its specific rate of display, however some queueing time may be allotted for buffering. As used herein, “best effort” refers to tasks that can be handled with variable bit rates and/or latency. As but one such example, a user that wants to view a video on their smart phone can wait for the smart phone to queue and post-process video.

In one embodiment, the load subsystem is a signal processor that manipulates electrical signals in the analog domain. In other words, information is conveyed via voltage and/or current. Functionally, analog processing may consume power to amplify/attenuate and/or synthesize intermediate signals and waveforms. Examples of analog signal processing include without limitation: amplification/attenuation, filtering, modulation/demodulation, signal conditioning, analog-to-digital (ADC)/digital-to-analog (DAC) conversion, automatic gain/frequency control (AGC/AFC), waveform synthesis, voltage/current regulation, mixing, phase shifting, isolation, equalization, and/or any other such operation. Analog signal processing is commonly used in sensors, telecommunications, audio processing, instrumentation, control, and any number of digital signal processing applications.

In one embodiment, the load subsystem is a signal processor that switches between operational modes (enables/disables circuitry) to perform signal processing. For example, a multicore processor may shift processing burden between cores (disabling a first core, transferring data, enabling a second core). Similarly, a processor may enable/disable processing elements between different power states (idle, low power, sleep, etc.). As another example, modems often wake-up to respond to communication requests (which could occur at any time), and sleep to save power when not in use.

As a related corollary, in “fixed-width” processing embodiments, data is processed using a fixed number of bits, such as 8, 16, 32, or 64 bits, etc. However, some embodiments may support “variable-width” processing and/or variable-length encoding which dynamically adjust the number of bits used to represent and process data based on the needs of a particular computation. This can be particularly useful for computational and/or memory efficiency. In other words, unnecessary computations may be avoided and/or unnecessary precision can be disregarded (e.g., saving memory space, reducing data transfers, etc.). Variable-width processing may be particularly useful in applications where lossy data is acceptable; examples include communication protocols, media playback, and/or neural network computing.

In one embodiment, the load subsystem is a signal processor that adjusts the operation of its gate-level circuitry. As a brief aside, gate-level circuitry refers to digital electronic circuits at the most fundamental level, where digital signals are represented with electrical voltages and drive currents (e.g., a Boolean “0” corresponds to GND voltage, a Boolean “1” corresponds to VCC voltage, etc.). So-called combinatorial logic emulates logical gates (e.g., AND gates, OR gates, NOT gates, NAND gates, NOR gates, XOR gates, XNOR gates, etc.). One example of an operational change that affects the power consumption of the signal processor is the voltage level (which may affect the robustness and reliability of transitions between logical levels). Sequential gates store logical values as electrical charges (e.g., registers, flip-flops, memory, and/or any other non-transitory computer-readable media). Operational changes that affect sequential gate logic include clock rate and/or drive current; in some cases, increasing/decreasing drive current may be used to enable faster clock rates and/or longer signaling distances.

The aforementioned techniques (switching operational modes, changing gate-level circuitry, and/or changing data sizes) are used in many computing devices including without limitation e.g., general-purpose processors, graphics processors (GPUs), neural network processors (NPUs), image signal processors (ISPs), digital signal processors (DSPs), modems, networking processors, field programmable gate arrays (FPGAs), codecs, application specific integrated circuits (ASICs), and/or any other semiconductor logic. Such components are often found in devices such as: computers, smartphones, laptops, terminals, servers, workstations, etc. While the foregoing discussion is primarily presented in the context of embedded and portable devices, the concepts may be broadly applied to any signal processing application that may need to dynamically adjust operation based on its power source.

### 5.3 Energy Transfer Components

Aspects of the present disclosure may be used in conjunction with energy transfer applications. Energy transfer technologies move energy from one device to another device, or store energy in another form for storage/delivery. The conservation of energy is a fundamental principle of physics that prevents energy from being created or destroyed in a closed system (e.g., the energy donor and energy recipient), however practical implementations have some efficiency losses due thermal waste, frictional losses, etc. Examples of energy transfer applications include for example: charging a battery, wireless power transfer, etc.

In one embodiment, the load subsystem delivers power to another device. For example, a power bank may provide energy to another device via a wired or wireless interface. Examples of wired interfaces include, without limitation: Universal Serial Bus (USB) and its derivatives, Lightning®/Magsafe® and any other proprietary charging interfaces, barrel connectors and AC plugs, etc. Wireless charging interfaces are currently less well established; circa 2023, a variety of different charging technologies exist including, without limitation: inductive charging, magnetic resonance charging, RF charging, ultrasonic charging, beamforming and/or resonant coupling, etc.

The energy transfer techniques described above are used in portable chargers, battery packs, power banks, jump starters, generators, and/or other power sources. In many cases, these devices may charge other devices such as smartphones, laptops, cameras, hand tools, power tools, car batteries, and/or other powered devices. These power storage devices are commonly used by working professionals, travelers, outdoor enthusiasts, and/or any other work application where access to power is limited.

### 6 User Interface Subsystem

Within the context of the present disclosure, system status and user feedback may be provided to/from the user via the user interface subsystem 700 (controlled by the control and data subsystem 900). Functionally, the user interface subsystem conveys (outputs) information to the user in visual, audible, and/or haptic form. Similarly, the user inputs information via physical or virtual interactions. The following discussions provide several illustrative embodiments of user interfaces, however, artisans of ordinary skill in the related arts given the contents of the present disclosure will readily appreciate that the virtually any user interface may be substituted with equal success.

User interfaces often incorporate mechanical elements including, without limitation: buttons, switches, knobs, levers, dials, joysticks, keyboards, mice, pedals, handles, and/or any other physical components that users may interact with to provide information to the system. For example, a user may press a physical button, click on an icon using a mouse, input text via a keyboard, etc.

User interfaces often incorporate visual elements, including without limitation: light emitting diodes (LEDs) and variants (e.g., OLEDs, MicroLEDs, etc.), liquid crystal displays (LCDs) and their variants (quantum dot displays (QLED), etc.), e-paper, cathode ray tube (CRT), projection displays, etc. In many cases, these visual elements may be used alone, or in conjunction with other modalities of input/output, for communication. As but one example, a set of light emitting diodes (LEDs) may be used to convey the estimated remaining voltage and charge of a corresponding set of batteries, based on position, color, intensity of illumination, and/or rate of blinking, etc. As another example, a graphical user interface using a virtual “desktop” may be displayed on a screen or touchscreen. The user may interact with icons on the desktop using a mouse and input text commands with a keyboard to see current power status (e.g., clicking on a battery icon opens a current estimated remaining voltage and charge for each battery, etc.).

Some user interfaces incorporate sound and/or audible information. For example, sounds and/or audio may be presented to the user (or captured) via a microphone and speaker assembly. In some situations, the user may be able to interact with the device via voice commands to enable hands-free operation.

Certain user interfaces incorporate motion and/or spatial information. For example, rumble boxes and/or other vibration media may provide haptic signaling. Cameras, accelerometers, gyroscopes, and/or magnetometers may be used to sense the user's physical motion and/or orientation to enable gesture-based inputs.

Most user interfaces incorporate multiple modalities of input. For example, augmented reality (AR) and/or virtual reality (VR) environments have been used in head-mounted apparatus (helmet, glasses, etc.). Such devices often incorporate visual, audio, and/or haptic information to the user.

### 7 Power Subsystem

Within the context of the present disclosure, the power subsystem 800 provides power to the load subsystem 600. During operation, the power subsystem 800 may also provide information to the control and data subsystem; this information may be used to monitor the status of the power subsystem and/or adjust operation.

As a brief aside, a “closed” electrical circuit provides a path for electric current to flow from a power source across a load; an “open” electrical circuit means that the path from a power source to a load has a gap which prevents the flow of electrical current. As previously alluded to, early electronics were designed for just a single power source and often directly connected power sources to the load, e.g., a battery might directly drive a bulb. Selectively providing power from multiple different power sources requires careful management of both the load requirements and the source output to prevent e.g., voltage/current mismatch, chemistry rate mismatch, capacity mismatch, etc.

Functionally, the power subsystem connects one or more power sources to the load subsystem. In addition, the power subsystem may also provide conditioning to compensate for differences between the required and provisioned electrical characteristics. For example, the power subsystem may ensure that the voltage and current provided from the selected batteries, solar cell, fuel generator, outlet, etc. match the load requirements in terms of nominal values, rate of use, frequency, etc.

Much like the load subsystem, the power sources of a power subsystem may also be characterized with source parameters. For example, source parameters for a battery might include its nominal voltage, maximum/minimum voltage, maximum current draw, etc. As a practical matter, many types of power sources do not provide information about their internal operations; for example, a battery may have a nominal voltage but the remaining charge is unknown. Similarly, a solar cell might provide power according to light which may vary, or an AC wall circuit might be shared with other loads.

Various embodiments of the present disclosure further characterize the power sources of a power subsystem with characteristic functions. As used herein, the term “characteristic function” and its linguistic derivatives refers to a relationship between known and unknown quantities. For example, the measurable initial voltage across the terminals of a battery may be used to estimate the unknown remaining charge of the battery. Similarly, the voltage/current and/or line noise of an AC power supply may be used to characterize the unknown loads that are sharing the circuit, etc. Characteristic functions may be empirically determined, based on historic data, defined by manufacturer, user, vendor, etc. More directly, any technique for estimating an unknown quantity from observable quantities maybe substituted with equal success.

### 7.1 Power Sources and Storage

Power sources may be characterized by their output voltage and maximum supported current draw. As previously noted, power sources cannot provide voltage/current according to idealized curves. For example, a typical battery may have been specified to a nominal voltage and total capacity (number of Coulombs), however, limitations of the battery chemistry and parasitic impedances will affect the actual maximum output current. Similar limitations exist for other forms of power generation (e.g., solar power, outlet power, fuel cells, etc.). Thus, different power sources may have different utility for meeting the dynamic needs of the load subsystem.

In one exemplary embodiment, the power subsystem uses batteries to store power. As previously noted, most batteries use one or more electrochemical cells to store energy as a chemical potential between reactants. During discharge, a chemical reaction converts high-energy reactants to lower-energy products, and the free-energy difference is delivered to the external circuit as electrical energy. Rechargeable battery chemistries allow for both charging and discharging cycles (e.g., charging the cell reverses the chemical process). Batteries come in a variety of sizes and chemistries. Examples of battery chemistries include, without limitation: alkaline, lithium-ion, lead-acid, nickel-cadmium, nickel-metal hydride, lithium polymer, zinc carbon, silver-oxide, zinc-air, sodium-ion, etc. Commonly available single-use sizes include without limitation: AA, AAA, C, D, etc. Rechargeable batteries are available in the legacy cell formats, but also have new formats such as: 10440, 14500, 18650, 26500, 32600, etc. Artisans of ordinary skill in the related arts will readily appreciate that virtually any battery chemistry and/or sizing may be used with equal success, given the contents of the present disclosure.

In some implementations, the power subsystem may incorporate internal batteries. Internal batteries are an integral part of the system's structure and are typically not removeable without e.g., specialized tools, voiding the device warranty, etc. Internal batteries are often used to e.g., support specialized power requirements, enable aggressive design form factors, incorporate proprietary technologies, and/or to reduce the cost of single-use/disposable type devices. In some implementations, the power subsystem may include housings and connection interfaces to allow for external battery connections; this allows the user to remove and replace batteries. Still other implementations may include both internal and external battery components.

While the foregoing discussion is presented in the context of electro-chemical cells, the concepts are broadly applicable to any power storage apparatus. Examples of other electro-chemical techniques include e.g. generators and fuel cells that consume fuel to generate electrical energy. Furthermore, the power subsystem may incorporate other sources of power such as electro-optical cells (solar cells), electrical interfaces (e.g., wall socket power), and/or any other source of power.

In one embodiment, the apparatus may house multiple power sources of different types and sizes. For example, a lantern might have 3× AA, 3×18500 (internal), 3× D cells. While these battery cells may each provide approximately 1.5V, the differences in their individual capacities, discharge rates, and chemistries may be suited to certain tasks. For example, the AA cells may be useful for low intensity, short duration tasks (e.g., low illumination settings, soft background music, etc.). The D cells may allow for high intensity, long duration tasks (e.g., high intensity lights, klaxon alarms, public address volumes, etc.). The rechargeable cells may be suitable to offload tasks and lengthen the usable life of the single-use cells. In some cases, the rechargeable cells may be charged in device when external power is available e.g., via solar cells, AC adaptors for outlets, etc.

### 7.2 Protection Circuitry

Dynamic loading may introduce undesirable harmonics in either the power sources themselves or the load they are connected to. As a related note, AC power from wall outlets may have residual harmonics and/or noise (which may even survive AC/DC conversion). Examples of undesirable effects that may be introduced by harmonics may include e.g., overshoot/undershoot, noise, interference, fluctuations, etc. In a separate but related tangent, directly coupling different power sources together (without additional power management logic) may create voltage mismatches that damage other circuitry or lead to cell premature failure, excessive discharge, overheating, leakage, and eventually rupture. In view of these issues, power conditioning circuitry may be used to protect the load subsystem and/or protection circuitry may be used to protect the power sources from one another.

Various embodiments of the present disclosure may incorporate power conditioning techniques to ensure that sourced power does not exceed acceptable tolerances, the rate of change does not exceed acceptable tolerances, and has (or does not have) certain frequency characteristics. As but one example, voltage and/or current regulation may ensure that overvoltage/undervoltage does not damage the load subsystem. Furthermore, additional resistance, capacitance, and/or inductance may be added to filter out problematic resonant frequencies. Non-linear components (such as Zener diodes, etc.) may also be used to ensure that excess power is diverted from sensitive circuits.

Certain harmonics may interfere with the normal operation of internal (or external) circuits. For example, duty cycle-based circuitry may introduce noise into the clocking signals of a nearby processor resulting in timing errors, etc. In some cases, certain frequencies are necessary for circuit operation. For example, some clock circuitry may use 60 Hz (from AC outlet power) to calculate timing; but synthesizing a 60 Hz power signal from battery-based power sources may not match the expected frequency content. Thus, frequency regulation may be used to stabilize frequencies, or synthesize additional frequencies.

More generally, artisans of ordinary skill in the related arts, given the contents of the present disclosure, will readily appreciate that any number of different power conditioning circuits may be used to clean and stabilize output power. Functionally, such conditioning circuits may e.g., regulate voltage, suppress transients, regulate frequencies, filter harmonics, filter noise, convert between voltage/current, etc.

### 7.3 Other Power Source Considerations

As a brief aside, alternating current (AC) and direct current (DC) are two fundamentally different ways of transmitting and using electrical energy. AC voltage periodically reverses direction. It continuously alternates between positive and negative cycles, creating a sinusoidal waveform. In contrast, DC voltage is unidirectional, meaning it flows in a constant direction from positive to negative terminals. AC is typically used for transmission and distribution because it can be easily transformed into different voltage levels using transformers. It is also used in most household and commercial electrical systems because it is easy to generate and distribute. Conversely, DC circuits are generally simpler; for example, a DC motor can vary speed and provides consistent torque (both of which are difficult to do with AC motors). DC circuits are commonly used in hand tools, electronic devices (like smartphones and laptops), automotive systems, and some specialized applications like solar photovoltaic systems.

In some embodiments, the system may incorporate rectifiers, inverters, and/or transformers. A rectifier may be used to convert alternating current (AC) voltage into direct current (DC) voltage. It “rectifies” the AC waveform by allowing current to flow in only one direction. An inverter does the opposite of a rectifier; it “inverts” DC voltage into AC voltage. Inverters generate a sinusoidal or modified sine wave AC output. Transformers can be used to increase (step-up) or decrease (step-down) the voltage level of an AC voltage without changing its frequency.

Transformers have a variety of useful properties. First, transformers may be used to match the voltage of electrical equipment to the available supply voltage. For example, industrial equipment may require a specific voltage level that differs from the standard distribution voltage. Secondly, transformers may be used to match the impedance between two components of a circuit, optimizing power transfer. This is particularly important in audio systems and radio frequency applications. Thirdly, transformers can introduce a controlled phase shift between the input and output voltages. This property is used in various applications, including power factor correction and inductive coupling in electronic circuits.

Another consideration for power sources is recharging functionality. During charging operation, the power subsystem may recharge a battery (converting electrical energy to a chemical potential for storage). The charging process is typically a multi-stage process that e.g., delivers a constant current to the battery until the battery reaches a specified voltage level (a so-called “constant current” stage), deliver a constant voltage until the battery no longer consumes current (a so-called “constant voltage” stage), and maintains a low current to the battery to top-up from self-discharge (a so-called “trickle charge” stage). In some variants, the power subsystem may include a charging circuit that additionally monitors the charging source and destination to ensure that the charging process operates safely (overcharging can damage batteries and/or result in catastrophic failures). In some embodiments, the power subsystem can both provide power, while also concurrently charging. For example, a device that may operate from wall socket power while also using excess power to charge its batteries.

More generally, artisans of ordinary skill in the related arts will readily appreciate that integrating multiple power sources within a single system to service a variety of dynamic loads may require additional supporting circuitry to address these differences. For example, a system may have a transformer to step-down AC power, a rectifier to convert the reduced AC power into DC power, and a charging circuit that manages the battery charging process. As another such example, an inverter may be used to convert DC power to AC power for devices that are usually used with wall outlets.

### 8 Control and Data Subsystem

Within the context of the present disclosure, the control and data subsystem 900 monitors the power subsystem 800 and/or the load subsystem 600 and adjusts power provisioning according to the dynamic loading activity of the load subsystem 600. The following discussions provide several illustrative embodiments of control and data subsystems, however, artisans of ordinary skill in the related arts given the contents of the present disclosure will readily appreciate that the virtually any control and data logic may be substituted with equal success.

In one exemplary embodiment, the control and data subsystem may include a processor and a non-transitory computer-readable medium that stores program instructions and/or data. During operation, the processor performs several actions according to a clock. These may be logically subdivided into a “pipeline” of processing stages. For example, one exemplary pipeline might include: an instruction fetch (IF), an instruction decode (ID), an operation execution (EX), a memory access (ME), and a write back (WB). During the instruction fetch stage, an instruction is fetched from the instruction memory based on a program counter. The fetched instruction is provided to the instruction decode stage, where a control unit determines the input and output data structures and the operations to be performed. These input and output data structures and operations are executed by an execution stage. For example, an instruction (LOAD R1, ADDR1) may instruct the execution stage to “load” a first register R1 of registers with the data stored at address ADDR1. In some cases, the result of the operation may be written to a data memory and/or written back to the registers or program counter.

Artisans of ordinary skill in the related arts will readily appreciate that the techniques described throughout are not limited to the basic processor architecture and that more complex processor architectures may be substituted with equal success. Most processor architectures implement e.g., different pipeline depths, parallel processing, more sophisticated execution logic, multi-cycle execution, and/or power management, etc.

As a practical matter, different processor architectures attempt to optimize their designs for their most likely usages. More specialized logic can often result in much higher performance (e.g., by avoiding unnecessary operations, memory accesses, and/or conditional branching). For example, a general-purpose CPU may be primarily used to control device operation and/or perform tasks of arbitrary complexity/best-effort. CPU operations may include, without limitation: best-effort operating system (OS) functionality (power management, UX), memory management, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks, and must account for branch disruption and/or arbitrary memory access.

As another example, a microcontroller may be suitable for embedded applications of known complexity. Microcontroller operations may include, without limitation: real-time operating system (OS) functionality, direct memory access (DMA) based hardware control, etc. Typically, microcontrollers are selected to have relatively short pipelining, short words (e.g., 8-bit, 16-bit, etc.), and/or fixed physical addressable space that may be shared with hardware peripherals. Typically, a microcontroller may be used with static/semi-static firmware that is application specific.

Application specific integrated circuits (ASICs) and field-programmable gate arrays (FPGAs) are other “dedicated logic” technologies that can provide suitable control and data processing. These technologies are based on register-transfer logic (RTL) rather than procedural steps. In other words, RTL describes combinatorial logic, sequential gates, and their interconnections (i.e., its structure) rather than instructions for execution. While dedicated logic can enable much higher performance for mature logic (e.g., 50×+ relative to software alternatives), the structure of dedicated logic cannot be altered at run-time and is considerably less flexible than software.

Application specific integrated circuits (ASICs) directly convert RTL descriptions to combinatorial logic and sequential gates. For example, a 2-input combinatorial logic gate (AND, OR, XOR, etc.) may be implemented by physically arranging 4 transistor logic gates, a flip-flop register may be implemented with 12 transistor logic gates. ASIC layouts are physically etched and doped into silicon substrate; once created, the ASIC functionality cannot be modified. Notably, ASIC designs can be incredibly power-efficient and achieve the highest levels of performance. Unfortunately, the manufacture of ASICs is expensive and cannot be modified after fabrication—as a result, ASIC devices are usually only used in very mature (commodity) designs that compete primarily on price rather than functionality.

FPGAs are designed to be programmed “in-the-field” after manufacturing. FPGAs contain an array of look-up-table (LUT) memories (often referred to as programmable logic blocks) that can be used to emulate a logical gate. As but one such example, a 2-input LUT takes two bits of input which address 4 possible memory locations. By storing “1” into the location of 0#b′11 and setting all other locations to be “0” the 2-input LUT emulates an AND gate. Conversely, by storing “0” into the location of 0#b′00 and setting all other locations to be “1” the 2-input LUT emulates an OR gate. In other words, FPGAs implement Boolean logic as memory—any arbitrary logic may be created by interconnecting LUTs (combinatorial logic) to one another along with registers, flip-flops, and/or dedicated memory blocks. LUTs take up substantially more die space than gate-level equivalents; additionally, FPGA-based designs are often only sparsely programmed since the interconnect fabric may limit “fanout.” As a practical matter, an FPGA may offer lower performance than an ASIC (but still better than software equivalents) with substantially larger die size and power consumption. FPGA solutions are often used for limited-run, high performance applications that may evolve over time.

### 8.1 Power Source Selection and Monitoring Logic

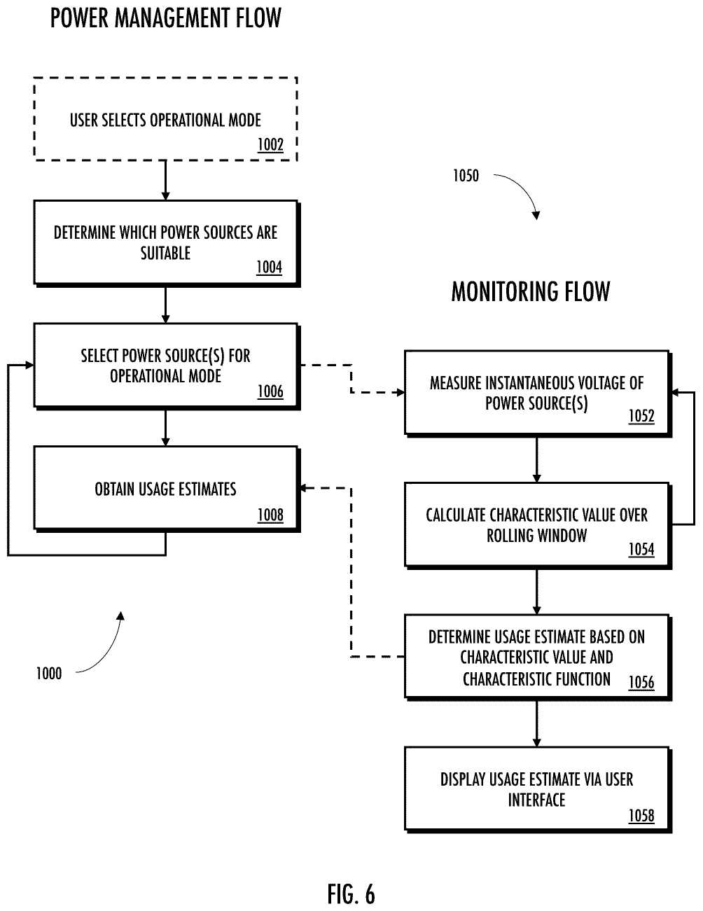

In one exemplary embodiment, data may be stored as non-transitory symbols (e.g., bits, bytes, words, and/or other data structures.) In one specific implementation, the memory subsystem is realized as one or more physical memory chips (e.g., NAND/NOR flash) that are logically separated into memory data structures. The memory subsystem may be bifurcated into program code (e.g., power management instructions 1000, and monitoring instructions 1050 of FIG. 6) and/or program data (not shown). In some variants, program code and/or program data may be further organized for dedicated and/or collaborative use. For example, a microcontroller and hardware driver may share a physical memory buffer to facilitate data transfer without memory indirection. In other examples, a microcontroller may have a dedicated memory buffer to avoid resource contention.

While the following discussion is presented in the context of two separate processes, the processes may be combined into a single process or further subdivided into three or more processes with equal success. Additionally, the following steps are discussed in the context of software instructions stored on memory and executed via a processor, however alternative implementations may use dedicated hardware (combinatorial and sequential logic) and/or firmware (software/hardware hybrids).

Referring now to the power management instructions woo, a user selects one or more operational modes from a plurality of operational modes (step 1002). As previously noted, operational modes may include lighting modes, charging modes, data transfer/playback modes, and/or any other set of active functions. In some embodiments, the operational modes may be selected based on user selection. For example, a user may manually select between USB charging and/or lighting using switches, buttons, or other user interface components. In other embodiments, the operational modes maybe selected based on the power management logic's internal heuristics and/or configuration. For instance, the power management logic may automatically charge plugged devices (e.g., after USB enumeration procedures, etc.) and/or automatically enable/disable lighting based on motion activation, etc. In some cases, the power management logic may prevent certain operational modes—for example, high current drain lighting may disable external charging and/or vice versa.

At step 1004, the power management logic determines a set of power sources that are suitable for the selected operational mode(s). Power sources may include, without limitation, dry cell batteries, rechargeable batteries, solar panels, fuel-based generators, fuel cells, piezo-electric cells, “mains” or “wall” power, and/or external power interfaces (e.g., USB, PoE), and/or any other source of electrical power.

In one embodiment, power management logic may be select between single-source or multiple source power supplies. As used herein, the term “single source” refers to a power supply that can select one power source from multiple power sources. For example, so-called “dual power” devices are devices that are designed to accept either single-use or rechargeable cells, but not at the same time. A dual power device may accept one battery cartridge for single-use batteries and another for rechargeable batteries. In another example, a single battery cartridge type can accept either single-use or rechargeable batteries (but not a mix of types). Dual power devices lack the onboard intelligence to manage different cell chemistries; thus, mixing cell types can result in the problems described above (reduced power, damage, and/or rupture). In some situations, dual power devices can also be inconvenient because the consumer may need to carry both options with them and to know in advance what their power needs will be.

As used herein, the term “multiple source” refers to a power supply that can combine power outputs from multiple power sources. For example, “hybrid power devices” may include circuitry that monitors power conditions of the different power sources and may make intelligent power management decisions on how to budget available power for a user of the device. Ideally, hybrid power devices can accommodate different power supplies, flexibly address different usages, and improve the convenience of use.

Various embodiments of the present disclosure may limit operational modes to certain suitable power sources. For example, 3 AA or 3 D batteries can both generate up to 4.5V but at different current draws; thus, either power supply may be suitable for certain lighting modes. Similarly, external charging may preferentially use the 3.7V lithium-ion, with a fallback to 3 AA batteries. In some cases, suitability preferences may be used to prioritize/de-prioritize operational modes; for example, the lantern may preserve its 3 D batteries for high-intensity lighting applications but not for charging. In other cases, suitability preferences may enable hybrid operation e.g., 4.5V can be concurrently sourced from AA and D cells without damage—but would result in harmful back current for the 3.7V lithium-ion. Some implementations may implement usage restrictions as static logic, other implementations may dynamically evaluate suitability based on a variety of factors. Examples of such factors may include e.g., minimum or maximum voltage/current/power requirements, user preferences, history of usage, battery condition, battery hysteresis (memory effects), availability of alternative power supplies, and/or any other operational consideration.

At step 1006, the power management logic selects one or more power sources from the set of power sources for the operational mode. In one exemplary embodiment, the power management logic may select from multiple types of batteries and allow the batteries to be used separately, or concurrently. The power management logic may intelligently monitor the availability of the power sources and the power remaining in all power sources; this information maybe used to switch between the power sources. Ideally, the power management logic maximizes the power available for the lowest lifetime cost, while also offering the highest flexibility in power options.

At step 1008, the power management logic obtains usage estimates from monitoring logic and may select (or re-select) another power source from the set of power sources for the selected operational mode.

Referring now to the monitoring instructions 1050, the instantaneous voltage of a power source is measured at step 1052. In one exemplary embodiment, voltage may be measured across a known impedance using an analog-digital conversion (ADC). Impedance based measurements may consider both resistance (frequency independent) and/or reactance (frequency dependent). For example, certain duty cycles and/or sampling frequencies may use frequency-dependent resonance/interference to amplify and/or attenuate measurements. Then, the monitoring logic calculates a characteristic voltage for a rolling window at step 1054.

As used herein, “instantaneous” refers to a specific measurement of a time-varying quantity at a specific time (an instance). “Characteristic” refers to a representative measurement for a time-varying quantity over a window of time. As previously noted, characteristic measurements may include averaging (mean, median, range), filtering, root-mean-square calculations, multiply-accumulate, and/or any other calculation that generates a characteristic non-zero value for a dynamic input.

In some embodiments, the granularity of the instantaneous measurements, the sample rate, and/or the size of the rolling window may be selected to provide a specific granularity. For example, a 4-bit ADC can generate up to 16 different values, an 8-bit ADC can generate up to 256 values. The sampling rate (e.g., 1 Hz (1/sec), 2 Hz (2/sec), . . . 40 Hz (40/sec), etc. affects the relative responsiveness of measurements. Accumulating these values over the rolling window could provide a substantial range of readings (e.g., accumulating 16 measurements could span 256-4096 different possible values over a duration between 200 ms-16 s). In some cases, the granularity may be specific to the operational mode. For example, a high-draw operational mode (e.g., 100% duty cycle light) will use battery power very quickly and may only need gross measurements at a relatively fast sample rate to detect the drop and/or rate of drop. In contrast, a low-draw operational mode (e.g., trickle charging) may need much finer granularity and/or a much slower sample rate to provide meaningful data. In other words, the monitoring logic may adjust its measurement accuracy/precision to suit the power consumption characteristics of the different operational modes.

At step 1056, the monitoring logic determines usage estimates based on the characteristic value and a characteristic function. In one exemplary embodiment, the characteristic function may be a look-up table that provides a correspondence between a characteristic value (e.g., a time averaged voltage measurement taken at a specific duty cycle and sample rate) to an estimated battery life based on the experimentally determined battery chemistry/characteristics. More generally, however, any suitable function may be substituted with equal success. Characteristic functions may be based on piecewise, point-wise, linear approximation, polynomial interpolation, etc.

At step 1058, the usage estimates are displayed via a user interface. Notably, the exemplary 4 LEDs at 3 different colors can represent 12 different usage estimates; this may be acceptable for most lantern applications. Other implementations may use any number of LEDs/colors to represent any number of different power information. More broadly, any scheme for representing usage may be substituted with equal success. For example, a sufficiently capable UI may provide usage estimates in more verbose or granular form e.g., a smart phone interface could provide a text readout with an estimated current draw (in amps/milliamps, etc.) and/or remaining capacity (amp hours, milliamp hours, etc.).

### 9 Additional Configuration Considerations

Throughout this specification, some embodiments have used the expressions “comprises,” “comprising,” “includes,” “including,” “has,” “having” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

As used herein any reference to any of “one embodiment” or “an embodiment”, “one variant” or “a variant”, and “one implementation” or “an implementation” means that a particular element, feature, structure, or characteristic described in connection with the embodiment, variant or implementation is included in at least one embodiment, variant or implementation. The appearances of such phrases in various places in the specification are not necessarily all referring to the same embodiment, variant or implementation.

As used herein, the term “computer program” or “software” is meant to include any sequence of human or machine cognizable steps which perform a function. Such program may be rendered in virtually any programming language or environment including, for example, Python, JavaScript, Java, C#/C++, C, Go/Golang, R, Swift, PHP, Dart, Kotlin, MATLAB, Perl, Ruby, Rust, Scala, and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die or distributed across multiple components.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method for dynamic power source management comprising:
obtaining load parameters based on an operational mode;
selecting a first power source from a set of power sources based on the load parameters and a set of source parameters that correspond to the set of power sources;
determining a usage estimate based on at least one measured voltage of the first power source and a characteristic function of the first power source; and
selecting a second power source from the set of power sources based on the usage estimate.

2. The method of claim 1, where the load parameters or the set of source parameters comprise one or more of: a nominal voltage, a maximum voltage, a minimum voltage, an average voltage, a nominal current, a maximum current, a minimum current, an average current, a duty cycle, a nominal slew rate, a maximum slew rate, a minimum slew rate, a nominal frequency, a spectral envelope, or a roll-off frequency.

3. The method of claim 1, where the set of power sources comprises an internal rechargeable battery and a housing for an external battery.

4. The method of claim 3, where the set of power sources further comprises at least one of an AC adaptor configured to obtain power from a power outlet, or a solar cell configured to convert light into power.

5. The method of claim 1, where the characteristic function comprises at least one of a first battery discharge curve for a rechargeable battery or a second battery discharge curve for a single-use battery.

6. The method of claim 1, where the operational mode is associated with a dynamic load having a duty cycle.

7. The method of claim 6, where the at least one measured voltage comprises a plurality of measured voltages over a rolling window based on the duty cycle.

8. An apparatus configured to dynamically manage power sources, comprising:
a load subsystem configured to operate according to a plurality of operational modes characterized by a corresponding plurality of load parameters;
a power subsystem configured to provide power from a set of power sources characterized by a corresponding set of source parameters and a corresponding set of characteristic functions;
a processor; and
a non-transitory computer-readable medium comprising instructions that when executed by the processor, cause the apparatus to:
obtain first load parameters based on a first operational mode of the plurality of operational modes;
select a first power source from the set of power sources based on the first load parameters;
determine a first usage estimate based on at least one measured voltage of the first power source and a first characteristic function of the first power source; and
select a second power source from the set of power sources based on the first usage estimate.

9. The apparatus of claim 8, where the load subsystem further comprises a light module that is configured to generate light based on a selectable duty cycle, and where the first load parameters are based on the selectable duty cycle.

10. The apparatus of claim 8, where the power subsystem further comprises an internal rechargeable battery and where the first characteristic function describes a relationship between the at least one measured voltage and a remaining battery capacity of the internal rechargeable battery.

11. The apparatus of claim 8, where the power subsystem further comprises an external housing configured to connect to an external battery and where the first characteristic function describes a relationship between the at least one measured voltage and a remaining battery capacity of the external battery.

12. The apparatus of claim 11, where the external battery comprises either a rechargeable battery or a single-use battery.

13. The apparatus of claim 8, further comprising a user interface subsystem configured to display the first usage estimate for the first power source.

14. The apparatus of claim 13, where the instructions further cause the apparatus to determine a second usage estimate based on a second characteristic function of the second power source and where the user interface subsystem is further configured to display the second usage estimate for the second power source.

15. An apparatus configured to dynamically manage power sources, comprising:
a load subsystem configured to operate according to a plurality of operational modes characterized by a corresponding plurality of load parameters;
a power subsystem configured to provide power from a set of power sources characterized by a corresponding set of source parameters and a corresponding set of characteristic functions;
a first logic configured to enable at least a first power source of the set of power sources based on a first operational mode, a first load parameter, and a first source parameter; and
a second logic configured to calculate a first usage estimate of the first power source based on a first characteristic function.

16. The apparatus of claim 15, where the load subsystem further comprises a light module that is configured to generate light based on a selectable duty cycle, and where the first load parameter is based on the selectable duty cycle.

17. The apparatus of claim 15, where the power subsystem further comprises an external housing configured to connect to an external battery, an internal rechargeable battery, and at least one of an AC adaptor configured to obtain power from a power outlet, or a solar cell configured to convert light into power.

18. The apparatus of claim 15, where the first operational mode is selected by a user and the first logic is further configured to obtain first load parameters based on the first operational mode.

19. The apparatus of claim 15, where the second logic is further configured to calculate the first usage estimate based on at least one measured voltage of the first power source and a characteristic function of the first power source and select a second power source from the set of power sources based on the first usage estimate.

20. The apparatus of claim 19, further comprising a third logic configured to calculate a second usage estimate of the second power source based on a second characteristic function and a user interface subsystem configured to display the first usage estimate and the second usage estimate.
